(19) United States
(12) Patent Application Publication
(10) Pub. No.: US 2026/0091735 A1
(43) Pub. Date: Apr. 2, 2026

(54) RAIL DEVICE AND METHOD OF ASSEMBLING THE SAME

(71) Applicant: Hyundai Transys Inc., Seosan-si (KR)

(72) Inventors: Chan Ju KIM, Gunpo-si (KR); Ingul Baek, Yongin-si (KR); Song Hee BAE, Seoul (KR); Eom Seok YOO, Hwaseong-si (KR); Ki Young YUN, Incheon (KR); Yongseong Jang, Gunpo-si (KR); Jin Wook CHOI, Hwaseong-si (KR)

(21) Appl. No.: 19/410,377

(22) Filed: Dec. 5, 2025

Related U.S. Application Data
(62) Division of application No. 18/663,935, filed on May 14, 2024.

(30) Foreign Application Priority Data
May 16, 2023 (KR) 10-2023-0063051

(51) Int. Cl. B60R 7/04; B60N 2/75

(52) U.S. Cl. CPC B60R 7/04; B60N 2/793; E05Y 2201/684

(57) ABSTRACT

Described is a rail device including a first rail having frame portions provided at two opposite sides thereof, and sliding grooves provided in the frame portions, a second rail having guides provided at two opposite sides thereof and configured to conform to the sliding grooves, the guide being configured to be slidable in a state in which the guide is coupled to the sliding groove, and elastic members coupled to the guides and each having at least one elastic portion being in contact with an inner wall surface of the frame portion and configured to elastically support the second rail.

### CROSS-REFERENCE TO RELATED APPLICATIONS

This application is a division of U.S. application Ser. No. 18/663,935, filed on May 14, 2024, which claims priority to and the benefit of Korean Patent Application No. 10-2023-0063051, filed on May 16, 2023, the entire contents of which are incorporated herein by reference.

### TECHNICAL FIELD

The present invention relates to a rail device, which is configured to allow a connection target to slide, and a method of assembling the same.

### BACKGROUND ART

In general, a console box may be provided between a driver seat and a passenger seat in a vehicle. The console box may be used to store items or serve as an armrest.

The console box may be coupled to a vehicle body by means of a rail device and slide. Because the console box may slide in the state in which the console box is coupled to the vehicle body by means of the rail device, an interior space of the vehicle may be efficiently used.

The rail device may include a first rail coupled to the vehicle body, and a second rail coupled to the console box and configured to slide in a state in which the second rail is coupled to the first rail. An elastic member may be coupled to the second rail. The elastic member may be tightly attached to the first rail and elastically support the second rail during a process of assembling the second rail to the first rail, such that the second rail may stably slide along the first rail.

However, because a gap between the first rail and the second rail is not uniform during the process of assembling the first rail and the second rail in the rail device in the related art, an elastic force of the elastic member applied to the second rail varies.

### Document of Related Art

### Patent Document

(Patent Document 1) Korean Patent Application Laid-Open No. 10-2020-0074713 (published on Jun. 25, 2020)

### SUMMARY OF THE INVENTION

The present invention has been made in an effort to solve the above-mentioned problem, and an object of the present invention is to provide a rail device, in which an elastic portion of an elastic member is plastically deformed by a jig assembled to a first rail so that an elastic force of the elastic member is uniformly applied to a second rail to allow the second rail to smoothly slide, and a method of assembling the same.

In order to achieve the above-mentioned object, the present invention provides a rail device including a first rail having frame portions provided at two opposite sides thereof, and sliding grooves provided in the frame portions, a second rail having guides provided at two opposite sides thereof and configured to conform to the sliding grooves, the guide being configured to be slidable in a state in which the guide is coupled to the sliding groove, and elastic members coupled to the guides and each having at least one elastic portion being in contact with an inner wall surface of the frame portion and configured to elastically support the second rail.

The elastic portion may include: a first elastic portion being in contact with an inner wall surface of an upper end of the frame portion and configured to be convex toward the inner wall surface of the upper end of the frame portion; and a second elastic portion being in contact with an inner wall surface of a lateral end of the frame portion and configured to be convex toward the inner wall surface of the lateral end of the frame portion.

The first rail may be connected to a vehicle body, and the second rail may be connected to a connection target.

The connection target may be a console box.

The elastic member may include: first coupling portions provided at two opposite upper and lower sides with the elastic portion interposed therebetween and configured to surround the guide; and second coupling portions provided at two opposite left and right ends and inserted into coupling grooves of the guide.

The present invention provides a method of assembling a rail device, the method including: step (a) of coupling a jig to a frame portion of a first rail so that a pressing portion of the jig is positioned in a sliding groove in the frame portion; and step (b) of inserting a guide of a second rail into the sliding groove to apply a pressing force of the pressing portion of the jig to an elastic portion of an elastic member coupled to the guide so that the elastic portion is plastically deformed.

The method may further include: step (c) of removing the jig from the first rail after step (b) so that the elastic portion is in contact with an inner wall surface of the frame portion.

The jig may include: a main body having an accommodation portion provided at one side directed toward the elastic member; and a pressing plate configured to constitute the pressing portion of the jig and coupled to a bottom of the accommodation portion.

Any one of an upper end, a lateral end, and a lower end of the frame portion may be inserted into the accommodation portion.

The pressing force of the pressing plate may be applied to the elastic portion in a state in which the pressing plate is inserted into the sliding groove so that the elastic portion is plastically deformed.

The elastic portion may include: a first elastic portion configured to be convex toward an inner wall surface of an upper end of the frame portion; and a second elastic portion configured to be convex toward an inner wall surface of a lateral end of the frame portion.

The jig may include: a first jig coupled to an upper end of the frame portion; a second jig coupled to a lateral end of the frame portion; and a third jig coupled to a lower end of the frame portion, the first elastic portion may be plastically deformed by a pressing plate of the first jig, and the second elastic portion may be plastically deformed by a pressing plate of the second jig.

According to the present invention, the elastic portion of the elastic member is plastically deformed by the jig assembled to the first rail so that the elastic force of the elastic member is uniformly applied to the second rail, such that the second rail may smoothly slide.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a state in which a second rail is assembled to a first rail according to an exemplary embodiment of the present invention.

FIG. 2 is a side view illustrating a state in which the second rail is assembled to the first rail according to the exemplary embodiment of the present invention.

FIG. 3 is a view illustrating a state made before the second rail is assembled to the first rail according to the exemplary embodiment of the present invention.

FIG. 4 is a view illustrating a state made before an elastic member is assembled to a guide of the second rail according to the exemplary embodiment of the present invention.

FIG. 5 is a view illustrating a state made before a jig and the second rail are assembled to the first rail according to the exemplary embodiment of the present invention.

FIG. 6 is a view illustrating a state in which the jig is assembled to the first rail according to the exemplary embodiment of the present invention.

FIG. 7 is a view illustrating a state in which the jig and the second rail are assembled to the first rail according to the exemplary embodiment of the present invention.

FIG. 8 is an enlarged view of part A in FIG. 7.

FIG. 9 is a cross-sectional view taken along line B-B in FIG. 8.

FIG. 10 is a view illustrating a state in which the jig is removed from the first rail according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present invention, the specific descriptions of publicly known related configurations or functions will be omitted when it is determined that the specific descriptions may obscure the subject matter of the present invention. Further, the exemplary embodiments of the present invention will be described below, but the technical spirit of the present invention is not limited thereto and may of course be modified and variously carried out by those skilled in the art.

Hereinafter, a rail device of the present invention will be described.

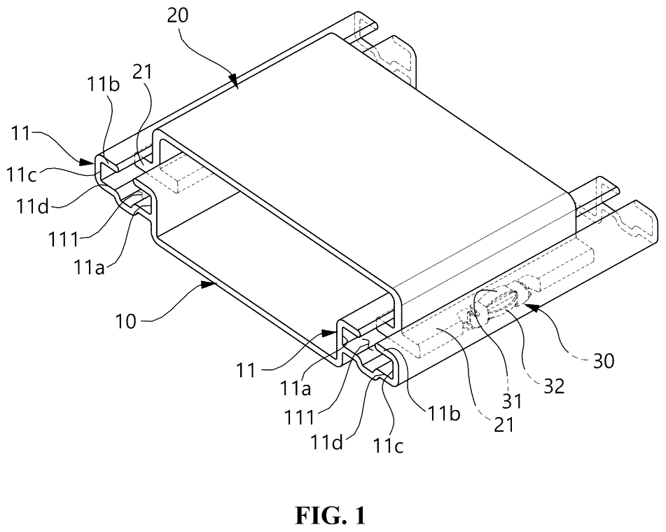

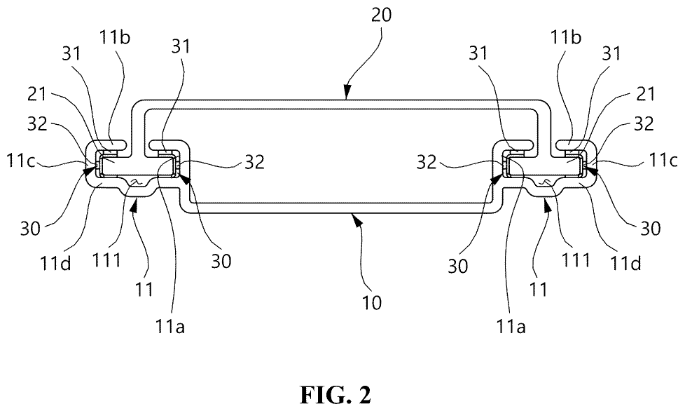

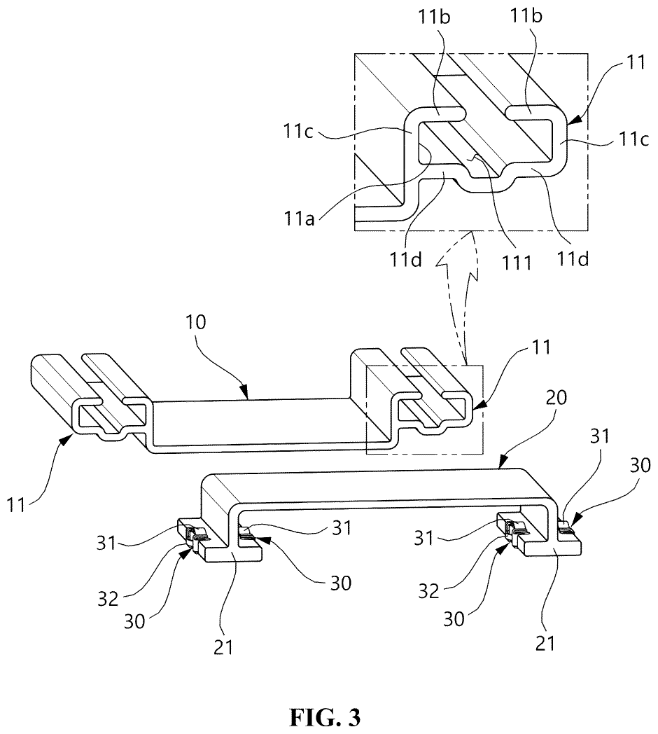

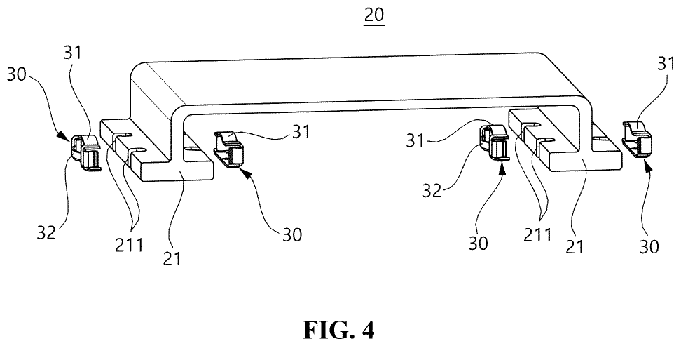

FIG. 1 is a perspective view illustrating a state in which a second rail is assembled to a first rail according to an exemplary embodiment of the present invention, FIG. 2 is a side view illustrating a state in which the second rail is assembled to the first rail according to the exemplary embodiment of the present invention, FIG. 3 is a view illustrating a state made before the second rail is assembled to the first rail according to the exemplary embodiment of the present invention, and FIG. 4 is a view illustrating a state made before an elastic member is assembled to a guide of the second rail according to the exemplary embodiment of the present invention.

As illustrated in FIGS. 1 to 4, a rail device according to the present invention may include a first rail 10, a second rail 20 assembled to the first rail 10, and elastic members 30 assembled to the second rail 20.

The first rail 10 may have frame portions 11 provided at two opposite sides thereof. A sliding groove 111 may be provided in the frame portion 11 and guide a sliding movement of the second rail 20.

The second rail 20 may have guides 21 provided at two opposite sides thereof. The guide 21 may be configured to conform to the sliding groove 111.

For example, the guide 21 may be configured in a shape such as a “L” that may be inserted into the sliding groove 111. The guide 21 may move along the sliding groove 111 in the state in which the guide 21 is inserted into the sliding groove 111.

The elastic members 30 may be coupled to two opposite left and right sides of the guide 21. The elastic member 30 may have elastic portions. The elastic portions may include a first elastic portion 31 and a second elastic portion 32. The first elastic portion 31 and the second elastic portion 32 may be in contact with inner wall surfaces 11a of the frame portion 11 and elastically support the second rail 20.

The elastic member 30 may allow the guide 21 to smoothly move along the sliding groove 111 in the state in which the guide 21 is inserted into the sliding groove 111.

The first elastic portion 31 may be in contact with an inner wall surface 11a of an upper end 11b of the frame portion 11. The first elastic portion 31 may be configured to be convex toward the inner wall surface 11a of the upper end 11b of the frame portion 11.

The second elastic portion 32 may be in contact with an inner wall surface 11a of a lateral end 11c of the frame portion 11. The second elastic portion 32 may be configured to be convex toward the inner wall surface 11a of the lateral end 11c of the frame portion 11.

The first rail 10 may be connected to a vehicle body (not illustrated). The second rail 20 may be connected to a connection target (not illustrated) such as a console box. A connection target, such as the console box, is slidable by the first rail 10 and the second rail 20, such that an interior space of the vehicle may be efficiently used.

For example, the rail device of the present invention may be used not only for the console box but also for all components required to slide in the vehicle.

The elastic member 30 may include first coupling portions 33 and second coupling portions 34.

The first coupling portions 33 may be provided at two opposite upper and lower sides with the elastic portions interposed therebetween. The first coupling portion 33 may be configured in a bent shape to surround the guide 21.

The second coupling portions 34 may be provided at two opposite left and right ends. The second coupling portion 34 may be configured in a bent shape that may be inserted into a coupling groove 211 provided in the guide 21.

The elastic member 30 may be securely assembled to the guide 21 of the second rail 20 by the first coupling portion 33 and the second coupling portion 34.

Next, a method of assembling the rail device of the present invention will be described.

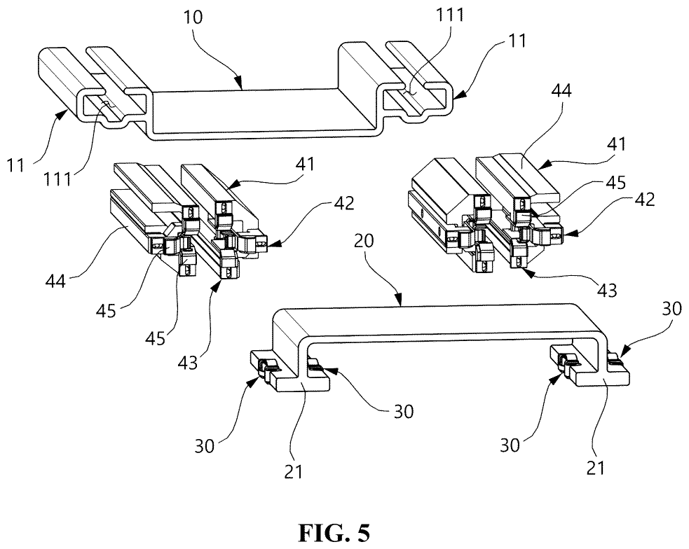

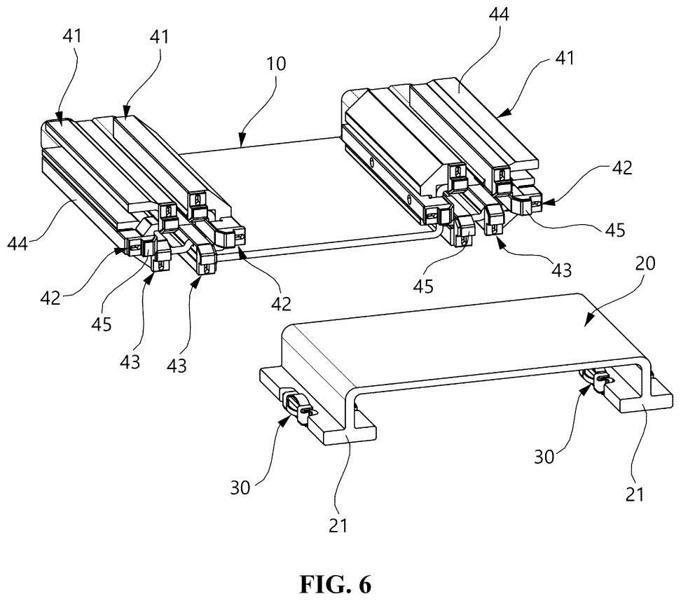

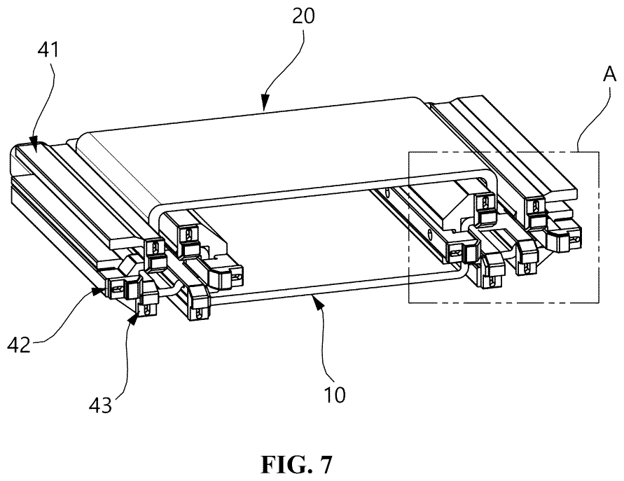

FIG. 5 is a view illustrating a state made before a jig and the second rail are assembled to the first rail according to the exemplary embodiment of the present invention, FIG. 6 is a view illustrating a state in which the jig is assembled to the first rail according to the exemplary embodiment of the present invention, and FIG. 7 is a view illustrating a state in which the jig and the second rail are assembled to the first rail according to the exemplary embodiment of the present invention.

As illustrated in FIGS. 5 to 7, the method of assembling the rail device according to the present invention may include a step of assembling a jig to the first rail 10, a step of assembling the second rail 20 to the first rail 10 and plastically deforming the elastic portions of the elastic member 30 coupled to the second rail 20 by a pressing portion of the jig, and a step of removing the jig from the first rail 10.

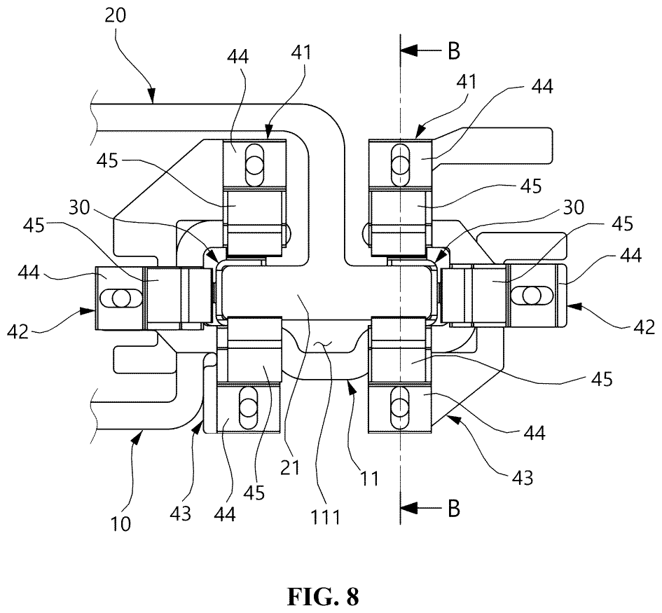

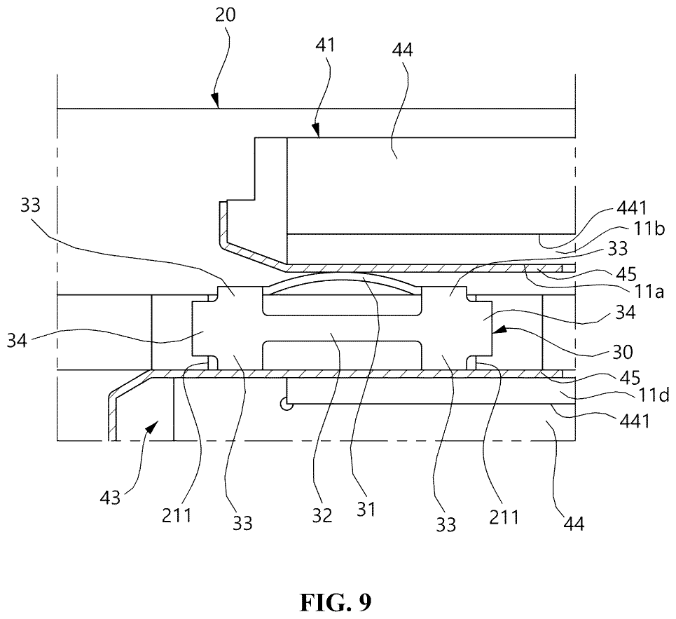

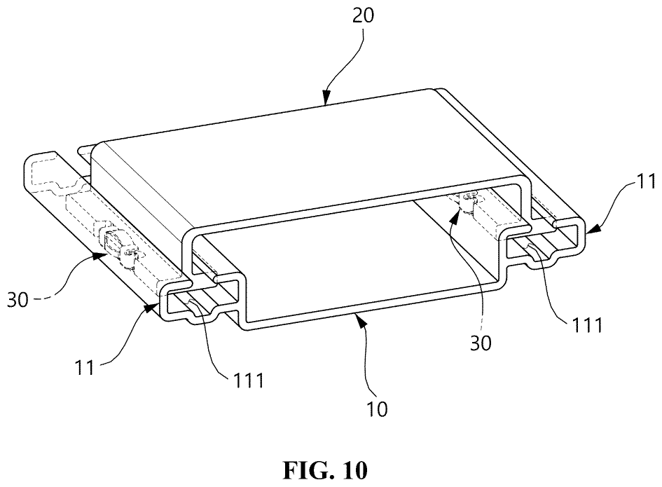

FIG. 8 is an enlarged view of part A in FIG. 7, FIG. 9 is a cross-sectional view taken along line B-B in FIG. 8, and FIG. 10 is a view illustrating a state in which the jig is removed from the first rail according to the exemplary embodiment of the present invention.

As illustrated in FIGS. 6 and 8, the jig may be coupled to the frame portion 11 of the first rail 10. The jig may include a first jig 41, a second jig 42, and a third jig 43.

The first jig 41 may be coupled to the upper end 11b of the frame portion 11. The second jig 42 may be coupled to the lateral end 11c of the frame portion 11. The third jig 43 may be coupled to a lower end 11d of the frame portion 11.

The first jig 41, the second jig 42, and the third jig 43 may be configured to have the same structure. The first jig 41, the second jig 42, and the third jig 43 may each include a main body 44 and a pressing plate 45.

The main body 44 may have an accommodation portion 441. The accommodation portion 441 may be provided at one side of the main body 44 directed toward the elastic member 30.

Any one of the upper end 11b, the lateral end 11c, and the lower end 11d of the frame portion 11 may be accommodated in the accommodation portion 441.

The pressing plate 45 may be coupled to a bottom of the accommodation portion 441. The pressing plate 45 may constitute a pressing portion of the jig.

As illustrated in FIGS. 8 and 9, when the first jig 41, the second jig 42, and the third jig 43 are coupled to the upper end 11b, the lateral end 11c, and the lower end 11d of the frame portion 11, the main body 44 may be positioned outside the frame portion 11, and the pressing plate 45 may be positioned in the sliding groove 111 of the frame portion 11.

When the guide 21 of the second rail 20 is coupled to the sliding groove 111 in the state in which the first jig 41, the second jig 42, and the third jig 43 are coupled to the frame portion 11 of the first rail 10, pressing force of the pressing plates 45 may be applied to the first elastic portion 31 and the second elastic portion 32 of the elastic member 30, such that the first elastic portion 31 and the second elastic portion 32 may be plastically deformed.

More specifically, the first elastic portion 31 may be plastically deformed by the pressing plate 45 of the first jig 41. The second elastic portion 31 may be plastically deformed by the pressing plate 45 of the second jig 42. The pressing plate 45 of the third jig 43 may serve to support the elastic member 30 so that the first elastic portion 31 and the second elastic portion 32 may be smoothly deformed plastically.

As illustrated in FIG. 10, in the state in which the first elastic portion 31 and the second elastic portion 32 are plastically deformed, all the first jig 41, the second jig 42, and the third jig 43 assembled to the first rail 10 are removed.

When all the first jig 41, the second jig 42, and the third jig 43 are removed from the first rail 10, the first elastic portion 31 and the second elastic portion 32, which are plastically deformed, may be in contact with the inner wall surface 11a of the upper end 11b and the inner wall surface 11a of the lateral end 11c of the frame portion 11.

As described above, the first elastic portion 31 and the second elastic portion 32, which are plastically deformed, provide uniform elastic force to the second rail 20, such that the guide 21 of the second rail 20 may smoothly slide along the sliding groove 111 of the first rail 10.

According to the present invention described above, the elastic portion of the elastic member is plastically deformed by the jig assembled to the first rail so that the elastic force of the elastic member is uniformly applied to the second rail, such that the second rail may smoothly slide.

The above description is simply given for illustratively describing the technical spirit of the present invention, and those skilled in the art to which the present invention pertains will appreciate that various modifications, changes, and substitutions are possible without departing from the essential characteristic of the present invention. Accordingly, the embodiments disclosed in the present invention and the accompanying drawings are intended not to limit but to describe the technical spirit of the present invention, and the scope of the technical spirit of the present invention is not limited by the embodiments and the accompanying drawings. The protective scope of the present invention should be construed based on the following claims, and all the technical spirit in the equivalent scope thereto should be construed as falling within the scope of the present invention.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of assembling a rail device, the method comprising:
coupling a jig to a frame portion of a first rail so that a pressing portion of the jig is positioned in a sliding groove in the frame portion; and
inserting a guide of a second rail into the sliding groove to apply a pressing force of the pressing portion of the jig to an elastic portion of an elastic member coupled to the guide so that the elastic portion is plastically deformed.

2. The method of claim 1, further comprising:
removing the jig from the first rail after the inserting of the guide so that the elastic portion is in contact with an inner wall surface of the frame portion.

3. The method of claim 1, wherein the jig comprises:
a main body having an accommodation portion disposed at one side facing the elastic member; and
a pressing plate having a pressing portion of the jig and coupled to a bottom of the accommodation portion.

4. The method of claim 3, wherein any one of an upper end, a lateral end, and a lower end of the frame portion is inserted into the accommodation portion.

5. The method of claim 4, wherein a pressing force of the pressing plate is applied to the elastic portion in a state in which the pressing plate is inserted into the sliding groove so that the elastic portion is plastically deformed.

6. The method of claim 1, wherein the elastic portion comprises:
a first elastic portion configured to be convex toward an inner wall surface of an upper end of the frame portion; and
a second elastic portion configured to be convex toward an inner wall surface of a lateral end of the frame portion.

7. The method of claim 2, wherein the jig comprises:
a first jig coupled to an upper end of the frame portion;
a second jig coupled to a lateral end of the frame portion; and
a third jig coupled to a lower end of the frame portion, and
wherein a first elastic portion is plastically deformed by a pressing plate of the first jig, and a second elastic portion is plastically deformed by a pressing plate of the second jig.
